(19) United States
(12) Patent Application Publication
(10) Pub. No.: US 2004/0263463 A1
(43) Pub. Date: Dec. 30, 2004

(54) Analog buffer and method for driving the same

(75) Inventor: Juhn-Suk Yoo, Seoul (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 10/878,538

(22) Filed: Jun. 29, 2004

(30) Foreign Application Priority Data
Jun. 30, 2003 (KR) 43969/2003

(51) Int. Cl. G09G 3/36

(52) U.S. Cl. 345/98

(57) ABSTRACT

An analog buffer includes a first switch and a first capacitor for receiving an analog signal, a comparing unit for compensating a voltage change of an output signal applied to a line upon receiving the analog signal through the first switch and the first capacitor, a second switch connected across an input terminal and an output terminal of the comparing unit, a third switch connected across the comparing unit, the first switch and the first capacitor and a fourth switch connected between the output terminal of the comparing unit and the line.

The present invention claims the benefit of Korean Patent Application No. 43969/2003 filed in Korea on Jun. 30, 2003, which is hereby incorporated by reference.

### BACKGROUND OF THE INVENTION

1. Field of the Invention

The present invention relates to an analog buffer and a method for driving the same, and more particularly, to an analog buffer and a method for driving the same in the transmission of a data signal in a data line of a liquid crystal display (LCD).

2. Description of the Background Art

In general, flat panel display devices have been intensively developed in recent years because of their light weight and portability. A liquid crystal display device is a flat panel display device on which research has been actively ongoing because of its high resolution and fast reaction speed. A dynamic image can be realized as a result of a liquid crystal display device having a high resolution and fast reaction speed.

By controlling an alignment direction of liquid crystal molecules having a directional characteristic along with polarization structures, the liquid crystal display device can transmit or block light by optical anisotropy according to the alignment direction of a liquid crystal. An active matrix type liquid crystal display device has a plurality of pixels arranged in a matrix form, and image information is selectively provided to each pixel through a switching element, such as a thin film transistor (TFT) provided at each pixel. An active matrix type liquid crystal display device is generally used due to its excellent image quality.

The substrate for the liquid crystal display device can be made of glass, which has a low cost and good processability. If the transistor is made of a polycrystalline silicon material having high electron mobility, the switching speed of the transistor can be fast and the size of the transistor can be reduced. However, since polycrystalline silicon is formed with a high temperature process, polycrystalline silicon transistor cannot be formed on a glass substrate of the liquid crystal display device. Thus, the thin film transistor on the glass substrate of the liquid crystal display device is made of an amorphous silicon material because such a transistor can be formed using a low temperature process.

A driving unit of the liquid crystal display device is formed as a plurality of integrated circuits (IC's) having fast switching speeds and small-size transistors. These integrated circuits are integrated at a high density because many switching elements are required to process a digital signal for the many lines in a liquid crystal display device. The transistors used in the driving unit of the liquid crystal display device are made of a polycrystalline silicon. As mentioned above, the thin film transistors used on the substrate of the liquid crystal display device are made of an amorphous silicon material by a low temperature process. However, the transistors used in the driving unit of the liquid crystal display device is made of a polycrystalline silicon material formed by a high temperature process, which can not be done on a glass substrate. Accordingly, the driving unit of the liquid crystal display device is in a tape carrier package (TCP) that includes the plurality of integrated circuits, which are individually fabricated on a separate single crystal silicon substrate. The tape carrier package (TCP) is connected to a substrate of a liquid crystal display device by a tape automated bonding (TAB) method. In an alternative, the driving unit includes a plurality of integrated circuits individually fabricated on a separate single crystal silicon substrate, which is mounted on the substrate of the liquid crystal display device by a chip-on-glass (COG) method.

In the cases of the driving unit of the liquid crystal display device being coupled to the substrate by either the TAB method or the chip-on-glass method, miniaturization and the simplification of the liquid crystal display device is limited since space is required for the driving unit on the liquid crystal display device. As lines for transmitting driving signals are increased in terms of number and length, various noises due to improper electromagnetic coupling, electromagnetic interference (EMI) or the like are generated, thereby degrading reliability of a product and increasing fabrication cost of the liquid crystal display device. A driving circuit-integrated liquid crystal display device in which the driving unit is mounted on a substrate of the liquid crystal display device has been desired. Therefore, research for forming the polycrystalline silicon transistor by a low temperature process has been actively pursued to fabricate a polycrystalline silicon thin film transistor directly on the substrate of the liquid crystal display device.

FIG. 1 is an exemplary view showing a schematic structure of a related art liquid crystal display device. As shown in FIG. 1, the related art liquid crystal display device includes a liquid crystal display panel 10 in which gate lines at regular intervals and data lines 30 at regular intervals are arranged to cross each other. Pixels 40 are defined in the liquid crystal display panel 10 between the gate lines 20 and the data lines 30. A gate driving unit 50 is mounted on the liquid crystal display panel 10 for applying a scan signal to the gate lines 20. A data driving unit 60 is also mounted on the liquid crystal display panel 10 for applying a data signal to the data lines 30.

A pixel electrode and a thin film transistor are provided in each pixel 40. The thin film transistor includes a gate electrode connected to one of the gate lines 20; a source electrode (not shown) connected to one of the data lines 30; and a drain electrode (not shown) connected to a pixel electrode (not shown). Gate pad parts (not shown) and data pad parts (not shown) are respectively formed at ends of the gate lines 20 and data lines 30.

The gate driving unit 50 sequentially applies a scan signal to the gate lines 20 through the gate pad parts, and the data driving unit 60 applies a data signal to the data lines 30 through the data pad parts, so that pixels 40 of the liquid crystal display panel 10 are individually driven, and thus a desired image is displayed on the liquid crystal display panel 10. The gate driving unit 50 and the data driving unit 60 mounted on the liquid crystal display panel 10 are fabricated in the same process that is used to fabricate a thin film transistor array substrate of the liquid crystal display panel 10.

As the driving circuit-integrated liquid crystal display device is increasingly developed to have a high resolution and a large size, the data lines and the gate lines increase in number and length, thereby increasing load. In addition, the amount of data signals which are processed to drive a higher resolution and a large liquid crystal display device increase greatly. Therefore, the driving unit of a high resolution and/or large liquid crystal display device has to be driven at a high speed. However, due to an increase in load of the data lines and the gate lines, a desired signal cannot be applied within a short period of time to achieve such a high speed. Accordingly, a liquid crystal display device having a high resolution and a large size necessarily requires an analog buffer, which can apply a desired signal within a short period of time, corresponding to a load of the data lines and the gate lines.

In general, since transistors of a single crystalline silicon material have good electrical characteristics, an operational amplifier using single crystalline silicon transistors is used as the analog buffer. On the contrary, since transistors of a polycrystalline silicon material has some poor electrical characteristics, an operational amplifier using polycrystalline silicon transistors has a great offset voltage and consumes a large amount of power due to a static current. For this reason, it is difficult to use an operational amplifier having polycrystalline silicon transistors as the analog buffer. Accordingly, the driving circuit of a liquid crystal display device requires an analog buffer that does not suffer from the poor electrical characteristics of polycrystalline silicon transistors, has a simple structure so as to reduce an area occupied thereby and consumes a small amount of power.

FIG. 2 is an exemplary view showing a related art analog buffer. As shown therein, the analog buffer includes a comparing unit (COMP1) for compensating for a voltage change of an output signal (OUT_SIG) applied to a data line (D1) upon receiving an analog signal (ANALOG_SIG) through a first switch (SW1) and a first capacitor (C1); a second switch (SW2) connected between an input terminal and an output terminal of the comparing unit (COMP1); and a third switch (SW3) connected to an output terminal of the comparing unit (COMP1) and between the first switch (SW1) and the first capacitor (C1). The first switch (SW1) and the second switch (SW2) are simultaneously turned on and off by a first control signal (CS1), and the third switch (SW3) is turned on and off by a second control signal (CS2).

FIG. 3 illustrates waveforms of the related art buffer illustrated in FIG. 2. A drive of the related art analog buffer will now be described in detail with reference to FIG. 3. First, the first switch (SW1) is turned on during an initializing period in which the first control signal (CS1) is applied as a high potential so that an analog signal (ANALOG_SIG) charges the first capacitor (C1). In addition, the second switch (SW2) is turned on so that an input terminal and an output terminal of the comparing unit (COMP1) are initialized. At this time, since a second control signal (CS2) is applied as a low potential, the third switch (SW3) is turned off. Thus, a voltage (Vana−Vth) is obtained by subtracting a threshold voltage (Vth) of the comparing unit (COMP1) from a voltage value (Vana) of the analog signal (ANALOG_SIG) charging the first capacitor (C1) during the initializing period.

Subsequently, the third switch (SW3) is turned on during a signal-applied period in which the second control signal (CS2) is applied as a high potential, so that the voltage value (Vana) of the analog signal (ANALOG_SIG) is applied to the data line (D1) through the turned-on third switch (SW3) as an output signal (OUT_SIG). At this time, since the first control signal (CS1) is applied as a low potential, the first switch (SW1) and the second switch (SW2) are turned off.

To compensate for errors that can arise due to electrical property differences amongst the transistors used for the comparing unit (COMP1) during the initializing period, the related art analog buffer driven, as mentioned above, stores an offset voltage at the first capacitor (C1) and simultaneously initializes an input terminal and an output terminal of the comparing unit (COMP1). The voltage value (Vana) of the analog signal (ANALOG_SIG) is applied to a data line (D1) through the turned-on third switch (SW3) as an output signal (OUT_SIG) during the signal-applied period. When a voltage of the output signal (OUT_SIG) applied to the data line (D1) is changed, the comparing unit (COMP1) changes a voltage of the input terminal to pull up or down a voltage value of the analog signal (ANALOG_SIG) together with the first capacitor (C1). That is, when a voltage of an output signal (OUT_SIG) applied to the data line (D1) rises, a voltage of the input terminal of the comparing unit (COMP1) drops and the comparing unit (COMP1) pulls down a voltage value (Vana) of the analog signal (ANALOG_SIG) together with the voltage on the first capacitor (C1). On the contrary, when the voltage of the output signal (OUT_SIG) applied to the data line (D1) drops, the voltage of the input terminal of the comparing unit (COMP1) rises, and the comparing unit (COMP1) pulls up the voltage value (Vana) of the analog signal (ANALOG_SIG) together with the voltage on the first capacitor (C1).

The voltage value (Vana) of the analog signal (ANALOG_SIG), whether pulled up or pulled down as described above, is applied to the data line (D1) as an output signal (OUT_SIG) through the third switch (SW3). Thus, a voltage change of the output signal (OUT_SIG) is compensated, and the compensated voltage is applied to the data line (D1). However, in the related art analog buffer as described above, when a load of the data line (D1) connected to the output terminal of the comparing unit (COMP1) is great, a large amount of power is consumed in order to initialize the input terminal and the output terminal to a threshold voltage (Vth). In addition, a time for initializing increases, thereby lengthening an initializing period.

When the initializing period is lengthened as described above, a signal-applied period is shortened, thus a transmission rate of a data signal applied to the data line (D1) connected to the output terminal of the comparing unit (COMP1) is degraded, and thus a driving speed of the liquid crystal display device is degraded.

### SUMMARY OF THE INVENTION

Accordingly, the present invention is directed to an analog buffer and a method for driving the same that substantially obviates one or more of the problems due to limitations and disadvantages of the related art.

An object of the present invention is to provide an analog buffer and a method for driving the same for minimizing power consumption and improving a transmission rate of a data signal in driving a data line of a liquid crystal display device.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, an analog buffer includes a first switch and a first capacitor for receiving an analog signal, a comparing unit for compensating a voltage change of an output signal applied to a line upon receiving the analog signal through the first switch and the first capacitor, a second switch connected across an input terminal and an output terminal of the comparing unit, a third switch connected across the comparing unit, the first switch and the first capacitor and a fourth switch connected between the output terminal of the comparing unit and the line.

In another aspect, a method for driving an analog buffer having a comparing unit for compensating a voltage change of an output signal applied to a line upon receiving an analog signal through a first capacitor includes, receiving the analog signal and storing the signal at the first capacitor, open-circuiting the output terminal of the comparing unit and the line, initializing the input terminal and the output terminal of the comparing unit, short-circuiting the output terminal of the comparing unit and the line to generate a compensated signal, and applying the compensated signal to the line as the output signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exemplary view showing a schematic structure of a related art liquid crystal display device.

FIG. 2 is an exemplary view showing a related art analog buffer.

FIG. 3 illustrates waveforms of the related art buffer illustrated in FIG. 2.

FIG. 4 is an exemplary view showing an analog buffer in accordance with one embodiment of the present invention.

FIG. 5 is view showing wave forms of first and second control signals and an output signal in FIG. 4.

FIG. 6 shows a first example of an element that is added to the buffer of FIG. 4 for preventing noise.

FIG. 7 shows a second example of elements added to the buffer of FIG. 4 for preventing noise.

FIG. 8 shows a third example of elements added to the buffer of FIG. 4 for preventing noise.

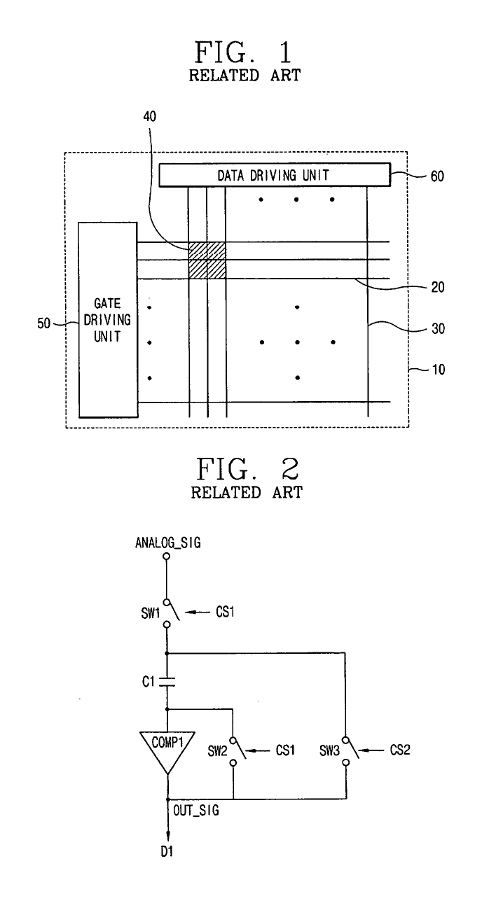

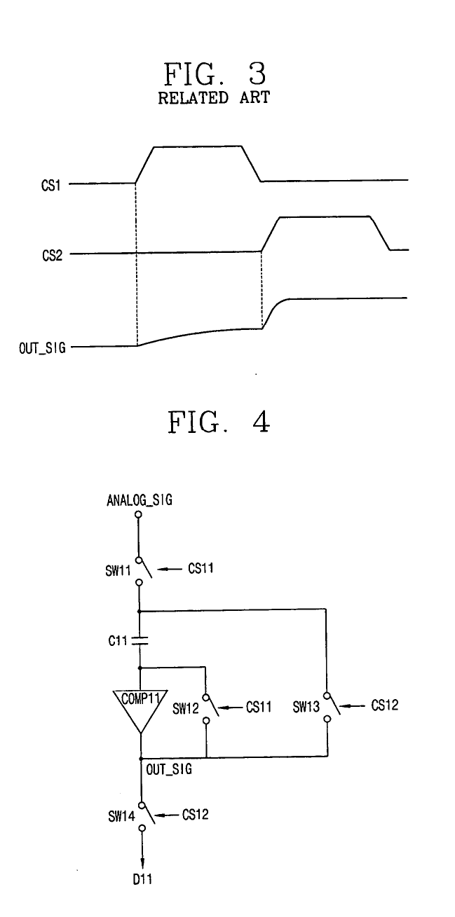

### DETAILED DESCRIPTION OF THE PREFERRED EMBODIMENTS

Reference will now be made in detail to the preferred embodiments of the present invention, examples of which are illustrated in the accompanying drawings.

FIG. 4 is an exemplary view showing an analog buffer in accordance with one embodiment of the present invention. As shown therein, the analog buffer includes a comparing unit (COMP11) for compensating a voltage change of an output signal (OUT_SIG) applied to a data line (D11) upon receiving an analog signal (ANALOG_SIG) through a first switch (SW11) and a first capacitor (C11); a second switch (SW12) connected across an input terminal and an output terminal of the comparing unit (COMP11); a third switch (SW13) connected across the comparing unit (COMP11), the first switch (SW11) and the first capacitor (C11); and a fourth switch (SW14) connected between the output terminal of the comparing unit (COMP11) and the data line (D11). The first switch (SW11) and the second switch (SW12) are simultaneously turned on and off by a first control signal (CS11), and the third switch (SW13) and the fourth switch (SW14) are simultaneously turned on and off by a second control signal (CS12). The first switch (SW11) and the second switch (SW12) may be transistors, which are simultaneously turned on and off upon in response to a first control signal at their gate electrodes, and the third switch (SW13) and the fourth switch (SW14) may be transistors, which are simultaneously turned on and off in response to a second control signal (CS12) at their gate electrodes. The comparing unit (COMP11) may be an inverter, a voltage amplifier or the like.

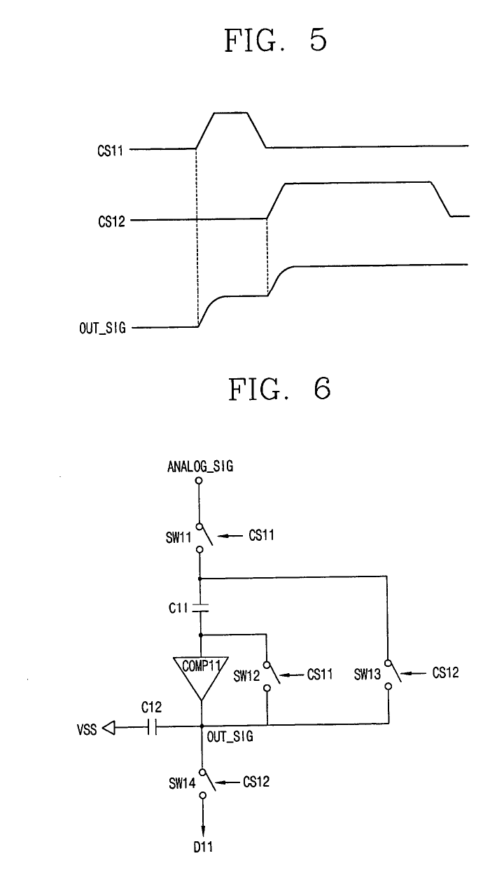

FIG. 5 is view showing wave forms of first and second control signals and an output signal in FIG. 4. Driving of the analog buffer in accordance with one embodiment of the present invention will now be described in detail with reference thereto.

First, the first switch (SW11) is turned on during an initializing period in which the first control signal CS11 is applied as a high potential, so that an analog signal (ANALOG_SIG) charges the first capacitor (C11), and the second switch (SW12) is also turned on so that an input terminal and an output terminal of the comparing unit (COMP11) are initialized. At this time, since a second control signal (CS12) is applied as a low potential, the third switch (SW13) and the fourth switch (SW14) are turned off. Accordingly, a voltage (Vana−Vth) is obtained by subtracting a threshold voltage (Vth) of the comparing unit (COMP11) from a voltage value (Vana) of the analog signal (ANALOG_SIG) charging the first capacitor (C1) during the initializing period.

Subsequently, the third switch (SW13) and the fourth switch (SW14) are turned on during a signal-applied period in which the second control signal (CS12) is applied as a high potential, so that a voltage value (Vana) of the analog signal (ANALOG_SIG) or a compensated signal is applied as an output signal (OUT_SIG) to the data line (D11) through the turned-on third switch (SW13) and fourth switch (SW14). At this time, since the first control signal (CS11) is applied as a low potential, the first switch (SW11) and the second switch (SW12) are turned off.

To compensate for errors that can arise due to electrical property differences amongst the transistors used for the comparing unit (COMP1) during the initializing period, the analog buffer in accordance with one embodiment of the present invention, as described above, is driven such an offset voltage is created at the first capacitor (C11) and the input terminal and the output terminal of the comparing unit (COMP11) are simultaneously initialized. At this time, since the fourth switch (SW14) connected between the output terminal of the comparing unit (COMP11) and the data line (D11) is cut off by a second control signal (CS12), the input terminal and the output terminal of the comparing unit (COMP1) are not affected by a load of the data line (D11). Accordingly, initialization can occur in a short period of time and power consumption can be reduced.

Subsequently, a voltage value (Vana) of the analog signal (ANALOG_SIG) is applied to the data line (D11) as an output signal (OUT_SIG) through the turned-on third switch (SW13) and the fourth switch (SW14) during the signal-applied period. When a voltage of the output signal (OUT_SIG) applied to the data line (D11) is changed, the comparing unit (COMP11) changes a voltage of the input terminal to thereby pull up or pull down a voltage value (Vana) of the analog signal (ANALOG_SIG), together with the voltage on the first capacitor (C11). That is, when a voltage of the output signal (OUT_SIG) applied to the data line (D11) rises, a voltage of the input terminal of the comparing unit (COMP11) drops, and the comparing unit (COMP11) pulls down a voltage value (Vana) of the analog signal (ANALOG_SIG), together with the voltage on the first capacitor (C11). On the contrary, when the voltage of the output signal (OUT_SIG) applied to the data line (D11) drops, a voltage of the input terminal of the comparing unit (COMP11) rises, and the comparing unit (COMP11) pulls up a voltage value (Vana) of the analog signal (ANALOG_SIG), together with the first capacitor (C11). The voltage value (Vana) of the analog signal (ANALOG_SIG), which is pulled up or pulled down, is applied to the data line (D11) as an output signal (OUT_SIG) through the third switch (SW13) and the fourth switch (SW14) so that a voltage change of the output signal (OUT_SIG) is compensated and the compensated voltage is applied to the data line (D11).

In the analog buffer in accordance with one embodiment of the present invention driven as described above, during the signal-applied period, a load of the data line (D11) rapidly increases at an early stage when the third switch (SW13) and the fourth switch (SW14) are simultaneously turned on. Accordingly, a phase margin of the comparing unit (COMP11) decreases, whereby noise, such as oscillation or the like, may occur in an output signal (OUT_SIG). Accordingly, elements for preventing a noise from in the output signal (OUT_SIG) may be added to the analog buffer in accordance with embodiments of the present invention in various forms. For example, elements may be implemented as shown in FIGS. 6 to 8.

FIG. 6 shows a first example of an element that is added to the buffer of FIG. 4 for preventing noise. As shown therein, a first auxiliary capacitor (C12) may be provided between the output terminal of the comparing unit (COMP11) shown in FIG. 4 and a ground potential (VSS). The first auxiliary capacitor (C12) is additionally provided in the analog buffer in accordance with this embodiment of the present invention such that, during an the initializing period, the initialization of the input terminal and the output terminal of the comparing unit (COMP11) to a threshold voltage (Vth) is somewhat delayed. Accordingly, noise is cut off from the output signal at an early stage when the output signal is generated for application to a line. Thus, noise is prevented from occurring at the output signal (OUT_SIG) such that an analog buffer in accordance with this embodiment of the present invention is stabilized, thereby improving reliability.

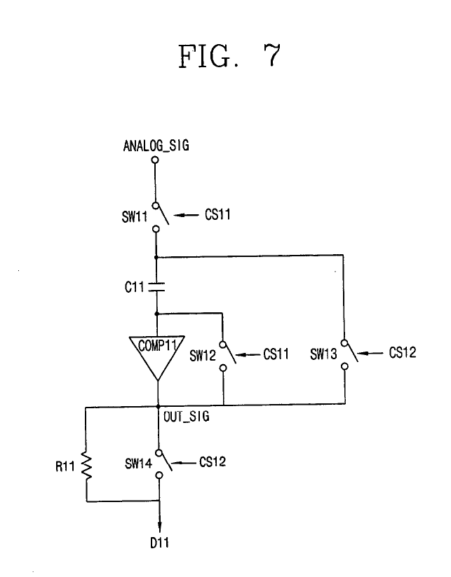

FIG. 7 shows a second example of elements added to the buffer of FIG. 4 for preventing noise. As shown in FIG. 7, a first auxiliary resistance (R11) can be provided between the output terminal of the comparing unit (COMP11) and the data line (D1) illustrated in FIG. 4. The first auxiliary resistance (R11) can be, for example, a transistor having a channel size that is ten times smaller than those of transistors applied as the first to fourth switches (SW11˜SW14) in the analog buffer. The first auxiliary resistance (R11) is additionally provided in the analog buffer in accordance with this embodiment of the present invention such that, during an the initializing period, the initialization of the input terminal and the output terminal of the comparing unit (COMP11) to a threshold voltage (Vth) is somewhat delayed. Accordingly, noise is cut off from the output signal at an early stage when the output signal is generated for application to a line. Thus, noise is prevented from occurring at the output signal (OUT_SIG) such that an analog buffer in accordance with this embodiment of the present invention is stabilized, thereby improving reliability.

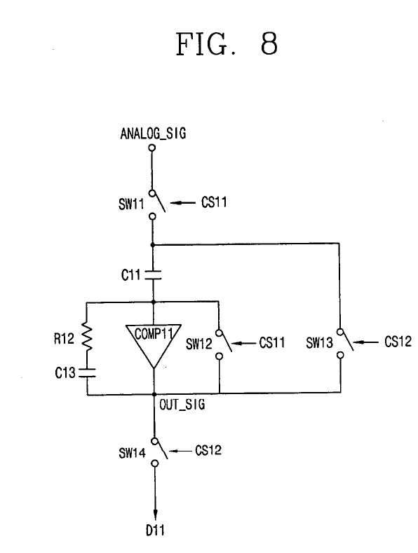

FIG. 8 shows a third example of elements added to the buffer of FIG. 4 for preventing noise. As shown in FIG. 8, a second auxiliary capacitor (C13) and a second auxiliary resistance (R12) are connected in series across the input terminal and the output terminal of the comparing unit (COMP11) illustrated in FIG. 4. The second auxiliary resistance (R12) can be a transistor having a channel size that is ten times smaller than those of transistors applied at the first to fourth switches (SW11˜SW14). The second auxiliary capacitor (C13) and the second auxiliary resistance (R12) are additionally provided in the analog buffer in accordance with this embodiment of the present invention such that, during an the initializing period, the initialization of the input terminal and the output terminal of the comparing unit (COMP11) to a threshold voltage (Vth) is somewhat delayed. Accordingly, noise is cut off from the output signal at an early stage when the output signal is generated for application to a line. Thus, noise is prevented from occurring at the output signal (OUT_SIG) such that an analog buffer in accordance with this embodiment of the present invention is stabilized, thereby improving reliability.

The analog buffer in accordance with the present invention can be provided in a gate driving unit or a data driving unit mounted in a driving circuit of a liquid crystal display device, and particularly, may be provided at an output terminal of the data driving unit applying a image signal to a data line (D11) of a liquid crystal display device. An analog buffer and a method for driving the same in accordance with the present invention can shorten an initializing period and thus reduce power consumption since an offset voltage is stored. In addition, the input terminal and the output terminal of the comparing unit can be initialized to a threshold voltage within a short period of time without influence of a load of a data line as the output terminal of the comparing unit and the data line are cut off during the initializing period when the input terminal and the output terminal of the comparing unit are initialized. Further, as the initializing period is shortened, a signal-applied period can be extended so that a transmission rate of a data signal applied to a data line can be improved and thus a driving speed of a liquid crystal display device can be improved. Furthermore, by adding elements for preventing a noise of an output signal from occurring in various forms to an analog buffer in accordance with the present invention, an analog buffer is stabilized, thereby improving reliability.

It will be apparent to those skilled in the art that various modifications and variations can be made in the an analog buffer and a method for driving the same of the present invention without departing from the spirit or scope of the invention. Thus, it is intended that the present invention cover the modifications and variations of this invention provided they come within the scope of the appended claims and their equivalents.

What is claimed is:

1. An analog buffer, comprising:
a first switch and a first capacitor for receiving an analog signal;
a comparing unit for compensating a voltage change of an output signal applied to a line upon receiving the analog signal through the first switch and the first capacitor;
a second switch connected across an input terminal and an output terminal of the comparing unit;
a third switch connected across the comparing unit, the first switch and the first capacitor; and
a fourth switch connected between the output terminal of the comparing unit and the line.

2. The analog buffer of claim 1, wherein the analog buffer is provided in a data driving unit mounted in a liquid crystal display device.

3. The analog buffer of claim 1, wherein the line is a data line of a liquid crystal display device.

4. The analog buffer of claim 1, wherein the first switch and the second switch are simultaneously turned on and simultaneously turned off, and the third switch and the fourth switch are simultaneously turned on and simultaneously turned off.

5. The analog buffer of claim 1, wherein the first switch and the second switch are respectively a first transistor and a second transistor, which are simultaneously turned on upon receiving a first control signal at their gate electrodes, and the third switch and the fourth switch are respectively a third transistor and a fourth transistor which are simultaneously turned on upon receiving a second control signal at their gate electrodes.

6. The analog buffer of claim 1, wherein the comparing unit includes one of an inverter and a voltage amplifier.

7. The analog buffer of claim 1, further comprising:
a first auxiliary capacitor between the output terminal of the comparing unit and a ground potential (VSS).

8. The analog buffer of claim 1, further comprising:
a first auxiliary resistance between the output terminal of the comparing unit and the line.

9. The analog buffer of claim 8, wherein the first auxiliary resistance includes a transistor having a channel size that is smaller than those of the first to fourth transistors applied as the first to fourth switches of the analog buffer.

10. The analog buffer of claim 1, further comprising:
a second auxiliary capacitor and a second auxiliary resistance being connected in series across the input terminal and the output terminal of the comparing unit.

11. The analog buffer of claim 10, wherein the second auxiliary resistance includes a transistor having a channel size that is smaller than those of the first to fourth transistors applied as the first to fourth switches of the analog buffer.

12. A method for driving an analog buffer including a comparing unit for compensating a voltage change of an output signal applied to a line upon receiving an analog signal through a first capacitor, comprising:
receiving the analog signal and storing the signal at the first capacitor;
open-circuiting the output terminal of the comparing unit and the line;
initializing the input terminal and the output terminal of the comparing unit;
short-circuiting the output terminal of the comparing unit and the line to generate a compensated signal; and
applying the compensated signal to the line as the output signal.

13. The method of claim 12, wherein the comparing unit compensates a voltage of the analog signal together with a voltage from the first capacitor by changing a voltage of the input terminal according to a voltage change of the output signal applied to the line.

14. The method of claim 12, wherein applying the analog signal to the line as the output signal further comprising:
cutting off a noise in the output signal at an early stage when the output signal is applied to the line.
